(19) United States
(12) Patent Application Publication
(10) Pub. No.: US 2025/0236434 A1
(43) Pub. Date: Jul. 24, 2025

(54) CONTAINER AND METHOD FOR MANUFACTURING THE SAME

(71) Applicant: Sonoco Development, Inc., Hartsville, SC (US)

(72) Inventor: Rebecca Silveston, Hartsville, SC (US)

(21) Appl. No.: 18/421,617

(22) Filed: Jan. 24, 2024

(51) Int. Cl. B65D 3/28; B31C 3/02; B31C 3/04; B32B 1/08; B32B 7/12; B32B 29/00; B65D 3/04; B65D 3/22

(52) U.S. Cl. CPC B65D 3/28; B31C 3/02; B31C 3/04; B32B 1/08; B32B 7/12; B32B 29/005; B65D 3/04; B65D 3/22; B32B 2250/02; B32B 2250/26; B32B 2255/12; B32B 2255/26; B32B 2439/40; B65D 2203/02

(57) ABSTRACT

Tubular containers and methods of manufacture are provided herein. The tubular container comprises an inner body ply and an outer body ply wrapped into a tubular shape comprising an outer layer and a barrier layer in face-to-face contact with the outer layer. The outer layer defines a first surface of the inner body ply, and the barrier layer defines a second surface of the inner body ply. The inner body ply further comprises a first edge and a second edge. The second edge is folded such that the second surface of the inner body ply adjacent the second edge contacts the second surface of the inner body ply adjacent the first edge to form an overlap. The first surface is disposed interior of the fold. The inner body ply further defines a seam formed in at least a portion of the overlap. The barrier layer is a voided polymer sealant.

### FIELD OF THE INVENTION

The present invention relates generally to containers, and more particularly to sealants which reduce seam thickness and improve barrier properties within containers.

### BACKGROUND

Food and drink products and other perishable items are often packaged in tubular containers which are sealed at both ends. These tubular containers typically include at least one structural body ply and are formed by spirally wrapping a continuous strip of body ply material around a mandrel to create a tubular structure. The tube is then cut into discrete lengths and fitted with closures to form the container.

Tubular containers of this type typically include a liner ply on the inner surface of the body ply. The liner ply prevents and/or resists the ingress or egress of liquids, gasses, and moisture. In some embodiments, the liner ply may be spirally wound with the body ply. Thus, the liner ply provides barrier properties and the body ply provides structural performance. The liner ply is generally made from multiple polymeric components, often comprising layers of different polymeric films laminated together to achieve certain desired properties. In addition, the liner ply may comprise layers of foil, metalized polymers, heat seal layers, and adhesives.

When the liner ply is spirally wound into a tubular container shape with the body ply, a portion of the liner ply is overlapped thereby forming a seam. The seam comprises at least two layers of the liner, and thus, the seam portion of the liner is bulkier than the rest of the liner and may protrude from the outer surface of the container. This bulk/protrusion may cause a gap between the liner and other layers of the container (e.g., outer layer) at and around the seam. Further, the additional layer of the liner at the seam may cause a loss of hermeticity between a bottom closure and the can sidewalls or a flexible membrane and the can rim or sidewalls. The bulk of the overlap creates an area of discontinuity along the periphery of the container, which presents difficulties when sealing the membrane to the container. Extra sealant and adhesive have been used to fill the discontinuities, however, this adds extra cost and complexity to the process.

Additionally, the overlaps formed by the seam may lead to weakened barrier properties. Through ingenuity and hard work, the inventor has developed a container having polymeric barrier properties, for use in packaging, and a method of making the same, such that the product may maintain constant barrier properties along the container.

### BRIEF SUMMARY

The present invention provides a tubular container comprising an inner body ply and an outer body ply. The inner body ply comprises a sealant layer which provides barrier properties to the container and reduces the bulk of the spirally bound seams. The sealant may be a voided polymer, wherein the voids are discontinuous throughout the sealant. The voided polymer provides certain barrier properties to the container, specifically both oxygen and moisture barriers, as oxygen and moisture are unable to penetrate through the discontinuous voids. Upon exposure to heat and/or pressure, the voids may collapse and cause several unexpectedly beneficial effects: (1) the sealant will densify, maintaining the barrier properties resulting from the voids, and (2) the thickness of the seam will decrease. In this regard, the reduced thickness of the seam prevents or reduces bubbles and/or creases at the ends of the tubular container at connection points (i.e., a rim) for closures, endcaps and/or membranes, thereby providing a stronger, more sustainable hermetic seal for the container and improving overall barrier properties of the container as a whole.

In an example embodiment a tubular container for products is provided. The tubular container comprises an inner body ply wrapped into a tubular shape comprising an outer layer and a sealant layer in face-to-face contact with the outer layer. The outer layer defines a first surface of the inner body ply and the sealant layer defines a second surface of the inner body ply. The inner body ply further comprises a first edge and a second edge. The second edge being folded such that the second surface of the inner body ply adjacent the second edge contacts the second surface of the inner body ply adjacent the first edge to form an overlap, the first surface being disposed within the interior of the fold. The inner body ply further defines a seam formed in at least a portion of the overlap. The sealant layer is a voided polymer sealant. The tubular container further comprises an outer body ply wrapped around the first surface of the inner body ply.

In some embodiments, the voided polymer sealant may be a light-weight voided polymer sealant. In some embodiments, the voided polymer sealant may be polyethylene. In some embodiments, the tubular container may comprise an adhesive disposed on the first surface of the body ply within the interior of the fold. In some embodiments, the voided polymer sealant may be polypropylene. In some embodiments, the voided polymer sealant may be polyethylene terephthalate. In some embodiments, the outer layer may comprise a composite material. In some embodiments, the outer layer may comprise a fibrous paperboard. In some embodiments, the tubular container may further comprise a label ply having an inner surface adhered in face-to-face contact with the outer body ply. In some embodiments, the outer body ply may be adhesively attached to the first surface of the inner body ply. In some embodiments, the tubular container may further comprise a liner adhesively attached to the second surface of the inner body ply.

In yet another embodiment, a method of forming a tubular container for products is provided. The method comprises supplying an outer layer defining a first outer layer surface and a second outer layer surface. The method further comprises applying a sealant to at least a portion of the second outer layer surface. The sealant and the outer layer forms a inner body ply, and is a voided polymer sealant. The outer layer defines a first surface of the inner body ply and the sealant defines a second surface of the inner body ply. The inner body ply further defines a first edge and a second edge opposite the first edge. The method further comprises folding the second edge of the inner body ply such that the first surface is disposed within the interior of the fold. The method further comprises winding the inner body to form a seam between the first surface of the first edge of the body ply and the first surface of the folded second edge of the body ply. The method further comprises applying at least one of heat or pressure about the seam. The method further comprises winding the outer body ply about the inner body ply such that an inner surface of the outer body ply is in face-to-face contact with the first surface of the inner body ply.

In some embodiments, the method may further comprise applying an adhesive to an inner surface of a label ply and winding the label ply about the outer body such that an outer surface of the outer body ply is in face-to-face contact with the inner surface of the label ply. In some embodiments, the method may further comprise winding a liner such that the liner is adjacent the second surface of the inner body ply. In some embodiments, the voided polymer sealant may be one of polyethylene, polypropylene, or polyethylene terephthalate. In some embodiments, the voided polymer sealant may reduce in thickness by at least 10% when exposed to one of heat or pressure. In some embodiments, the voided polymer sealant increases in density by at least 5% when exposed to at least one of heat or pressure. In some embodiments, the voided polymer sealant may be flood coated onto the second surface of the second outer layer surface.

In yet another example embodiment a tubular container for products is provided. The tubular container comprises a spirally-wound inner body ply layer in strip form defining an inner layer of a substantially cylindrical tubular container. The tubular container further comprises a spirally-wound outer body ply layer in strip form defining an outer layer of the substantially cylindrical tubular container. The outer body ply layer is wrapped around the outer surface of the inner body ply layer. The tubular container comprises a first end and a second end. The tubular container further comprises an inner body ply comprising a first edge and a second edge, the first and second edges extending longitudinally in strip form. The first edge and the second edge overlap thereby defining a seam between the first edge of the inner body ply and the second edge of the inner body ply. The inner body ply defines a first surface and a second surface. The first surface comprising an outer layer in face-to face contact with the outer body ply layer. The second surface comprises a sealant layer in face-to-face contact with the outer layer. The sealant layer being a voided polymer sealant.

In some embodiments, the tubular container may further comprise a spirally-wound liner in strip form defining an inner layer of the substantially cylindrical tubular container. The liner may be in face-to-face contact with the sealant layer.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates a perspective view of a tubular container, in accordance with some embodiments discussed herein;

FIG. 2 illustrates an example cross-sectional view of the composition of an example container taken across line 2-2 in FIG. 1, in accordance with some embodiments discussed herein;

FIG. 3A illustrates an example cross-sectional view of an outer layer of a tubular body, in accordance with some embodiments discussed herein;

FIG. 3B illustrates an example cross-sectional view of an edge of an outer layer with sealant disposed thereon, in accordance with some embodiments discussed herein;

FIG. 3C illustrates an example cross-sectional view of a folded edge of the outer layer of FIG. 3B, in accordance with some embodiments discussed herein;

FIG. 3D illustrates an example seam of the tubular body, taken along line 1A illustrated in FIG. 1, in accordance with some embodiments discussed herein; and

FIG. 3E illustrates the example seam shown in FIG. 3D after heating, in accordance with some embodiments discussed herein;

FIG. 4A illustrates a cross-sectional view of an example voided polymer sealant, in accordance with some embodiments discussed herein; and

FIG. 4B illustrates a cross-sectional view of the example voided polymer sealant illustrated in FIG. 4A, after exposure to heat or pressure, in accordance with some embodiments discussed herein.

### DETAILED DESCRIPTION

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

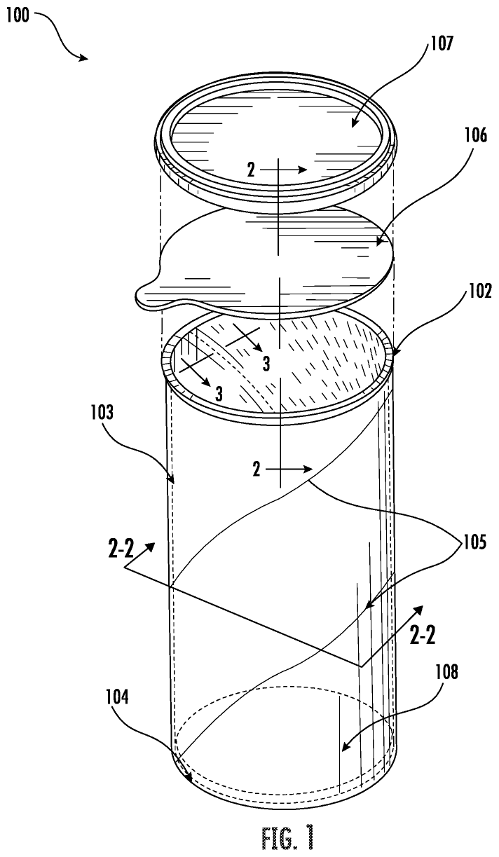

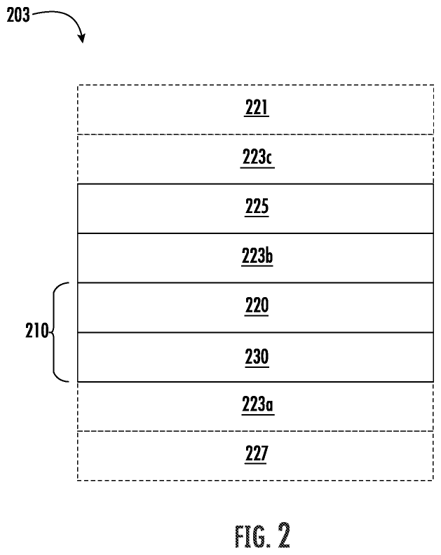

A tubular container 100 according to the present invention is illustrated in FIG. 1. Although illustrated as having a circular cross-section, the container 100 may have any cross-sectional shape which can be formed by wrapping an inner body ply (e.g., 210 FIG. 2), an outer body ply (e.g., 225 FIG. 2), optionally a label ply (e.g., 221 FIG. 2) and optionally a liner (e.g., 227 FIG. 2) around an appropriately shaped mandrel. In other embodiments, a linear draw may be used to form the container 100. In an embodiment, the container 100 may be any container that utilizes an anaconda or overlapping fold and need not even be cylindrical.

In some embodiments, the container 100 comprises at least one sidewall 103 which extends between a top end 102 and a bottom end 104 of the container 100. In some embodiments, such as when the container has a square cross section, the container 100 may comprise multiple sidewalls, such as four sidewalls. Any number of sidewalls known in the art is contemplated herein.

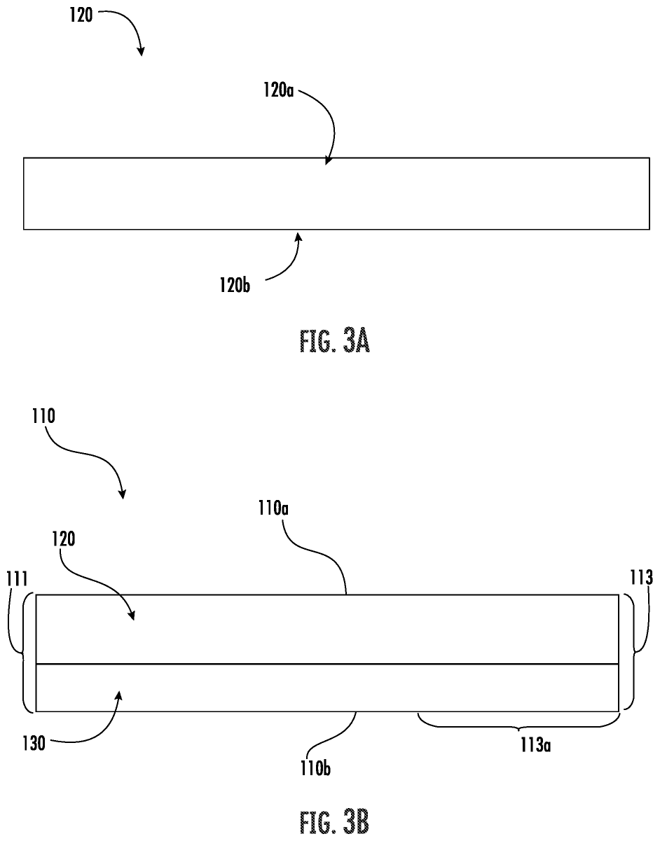

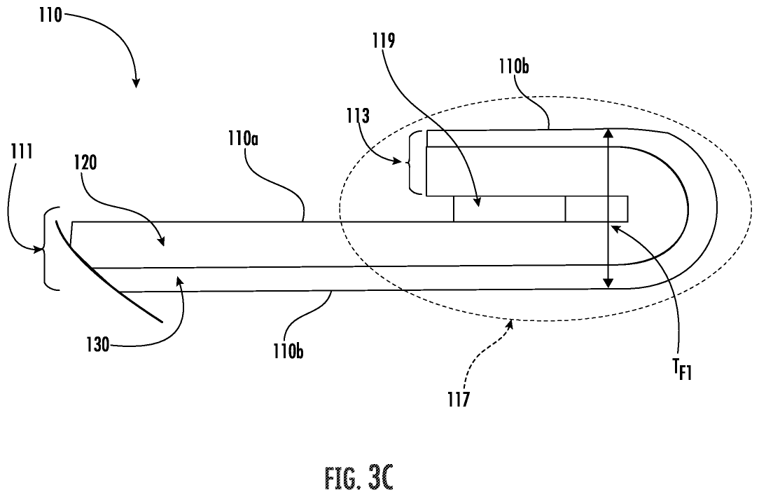

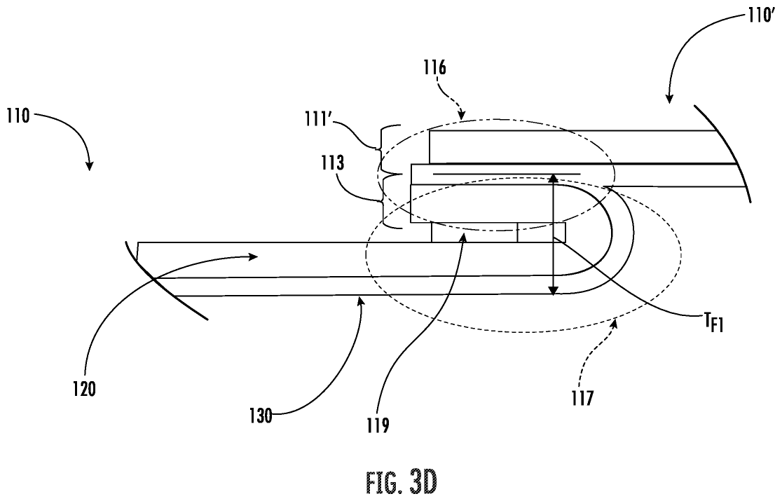

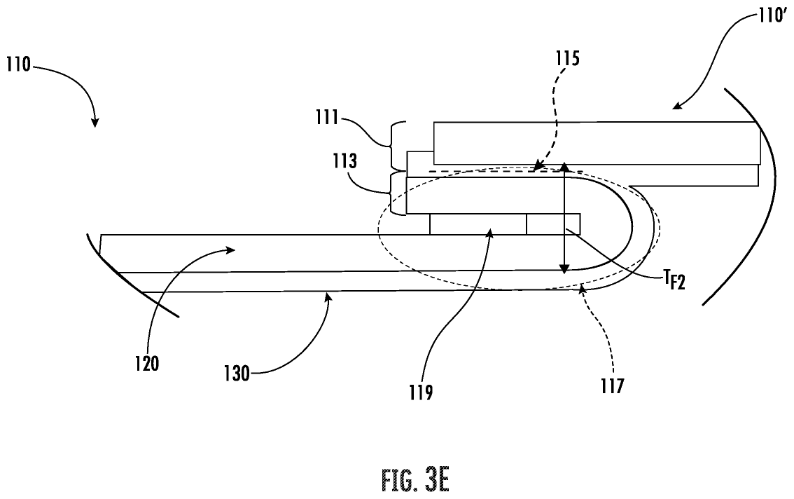

The embodiment of the container 100 illustrated in FIG. 1 comprises a single sidewall 103 which comprises an inner body ply (e.g., 110 FIG. 3B) formed of an outer layer (e.g., 120 FIG. 3B) and a sealant (e.g., 130 FIG. 3B) and an outer body ply (e.g., 225 FIG. 2) wound together. In some embodiments, an optional label ply (e.g., 221 FIG. 2) may be adhered to the exterior of the outer body ply, and a liner (e.g., 227 FIG. 2) may be adhered to the interior of the inner body ply. In an embodiment, the container 100 does not comprise a label ply, and instead, any printing or labeling may be disposed on the exterior surface of the outer body ply.

In some embodiments, the container 100 may include a hermetically-sealed, removable membrane-type lid 106 and a reusable end cap 107 that snaps into place over the lid 106. In some embodiments, the reusable end cap 107 may be composite material, a plastic material, or other paper-based recyclable material. In some embodiments, the top end 102 of the container sidewall 103 may be rolled inwardly or outwardly so as to form a bead or flange. The membrane lid 106 may be hermetically-sealed to the top of the bead using an adhesive. The end cap 107 may be snapped over the bead and reused repeatedly after the membrane lid 106 is removed.

In some embodiments, a bottom end closure 108 may be permanently affixed to the sidewall 103 such as through a deep recessed closure, permanently adhered or sealed closure, double seam, pinch seam or crimp seam. Various end closures may be used, depending upon the type of product which is to be packaged. End closure 108 may be plastic, paper, metal, any material known in the art. In some embodiments, the material used for the end closure 108 may be different than the material used for the sidewall 103. In some embodiments, the end closure 108 materials may be the same as those used in the sidewall.

The tubular container 100 may define one or more seams 105 extending between the top end 102 and the bottom end 104 of the container 100. In some embodiments, each layer of the sidewall 103 (e.g., inner body ply 210, outer body ply 225, liner 237 FIG. 2) may comprise a seam. The seam 105 as illustrated in FIG. 1 may be formed by overlapping an edge of the outer body ply onto a different portion of the outer body ply, as it is wrapped about a mandrel. In some embodiments, the seams 105 may extend helically about the circumference of the tubular container 100.

FIG. 2 illustrates an example composition of the sidewall 203 of the container. In some embodiments, each of the layers may be spirally-wound about one another to form the container 200. The container 100 may be a composite container. In some embodiments, the sidewall 203 may comprise an outer body ply 225 adhered in face-to-face relation to an inner body ply 210 with an adhesive 223b. An inner body ply 210 may comprise a sealant 230 disposed on an outer layer 220.

The outer body ply 225 may comprise a paperboard ply. For example, the outer body ply 225 may be a fibrous paper board, cardboard, paper stock, densified paper, or other rigid paper, to provide structure to the container. The paperboard utilized in the outer body ply 225 may be permeable such that oxygen and moisture may pass through the outer body ply 225. Thus, additional barrier layers may be utilized in the container construction, to prevent spoilage of the contents within the container.

Optionally, one or more liners 227 may be applied to the interior of the container to create an internal barrier layer. Specifically, the one or more liner 227 may have an inner surface facing the interior of the container (e.g., food facing) and an outer surface positioned in face-to face contact with the inner body ply 210, specifically the sealant 230. The liner 227 may comprise a moisture and/or gas barrier layer. In some embodiments, the liner ply 227 may be substantially formed of a polymeric material, however the liner ply 227 may be constructed of various combinations of polymeric layers, paper layers and metals, such as aluminum foils. In some embodiments, the liner 227 may be a coating, a film, or may be coextruded onto the inner body ply 210. In some embodiments, the one or more liners 227 may be adhered to the inner body ply 210 with an adhesive layer 223a. In some embodiments, the adhesive layer 223a may be applied to the liner 227 before application onto the inner body ply 210, while in other embodiments the adhesive layer 223a may be applied to the inner body ply 210 prior to application of the liner 227.

The inner body ply 210 may be wound as described above forming an anaconda fold securing the inner body ply 210. The sealant layer 230 may be adjacent the liner 227, and an outer layer 220 may form the exterior of the inner body ply 210. As discussed, in some embodiments, the outer body ply 225 may be adhered to the outer layer 220 with an adhesive 223b. Optionally, in some embodiments, a label 221 may be adhesively applied to the outer body ply 225 with an adhesive 223c, while in other embodiments the outer body ply 225 may be printed. In some embodiments, the inner body ply 210 and the outer body ply 225 may comprise other treatments prior to and during container formation. For example, in some embodiments, a lubricant may be applied onto the sealant prior to wrapping to allow the sealant to slide smoothly. In other embodiments, the outer body ply 225 and/or the inner body ply may be subject to a corona treatment.

As the focus on recyclability increases and the materials used to form containers become thinner and more porous (e.g., paper products) the barrier layers (e.g., liners) become susceptible to breach, for example, due to knicks, tears, or punctures. Seals and liners are especially susceptible to breach during container filling and transport. To explain, the crisps, chips, or other product positioned within the container may move around during filling and transport and may actually cut into or through the inner layers of the container (e.g., the liner 227) as they shift about, thereby breaching the barrier and causing spoilage of the product contained therein. This particularly happens in the locations at and around folds or seams, such as an anaconda fold in a spiral container. The sharp edges of the chips may cut through or into the sealant in the location of the fold or seam which extends slightly into the interior space of the container (i.e., is not flush with the sidewall).

Thus, to improve barrier properties, the inner body ply may comprise a sealant 230 disposed on an outer layer, the sealant being configured to provide barrier properties to the container. With reference to FIG. 3A, an outer layer material 120 may extend longitudinally, and may define a first outer layer surface 120a and a second outer layer surface 120b opposite the first outer layer surface 120a.

As illustrated in FIG. 3B the second outer layer surface 120b of the outer layer material 120 may be coated with a sealant 130, defining an inner body ply 110. The sealant 130, as discussed herein, may be a voided polymer sealant. In some embodiments, the sealant 130 may be flood coated onto the outer layer material 120, while in other embodiments the sealant 130 may be pattern applied to the outer layer material 120. As will be discussed herein, when pattern applied, the sealant 130 may be applied to the portion of the second outer layer surface 120b which will form the anaconda fold.

The inner body ply 110, may extend longitudinally in strip form defining a first edge 111 and a second edge 113, opposite one another. In this regard, the term “edge” refers to the outer most end of the ply, which extends along a length of the inner body ply 110. The inner body ply 110 may define a first surface 110a corresponding to the first outer layer surface 120a, and a second surface 120b, corresponding to the sealant 130 layer.

In some embodiments, the thickness of the sealant 130 may be at least 10 microns, at least 20 microns, or even at least 30 microns. In some embodiments, the sealant 130 may define a gradient thickness between each of the first edge 111 and the second edge 113. In this regard, the sealant 130 may be thinner at and adjacent to the first edge 111 and the second edge 113, and thicker away from the first edge 111 and the second edge 113.

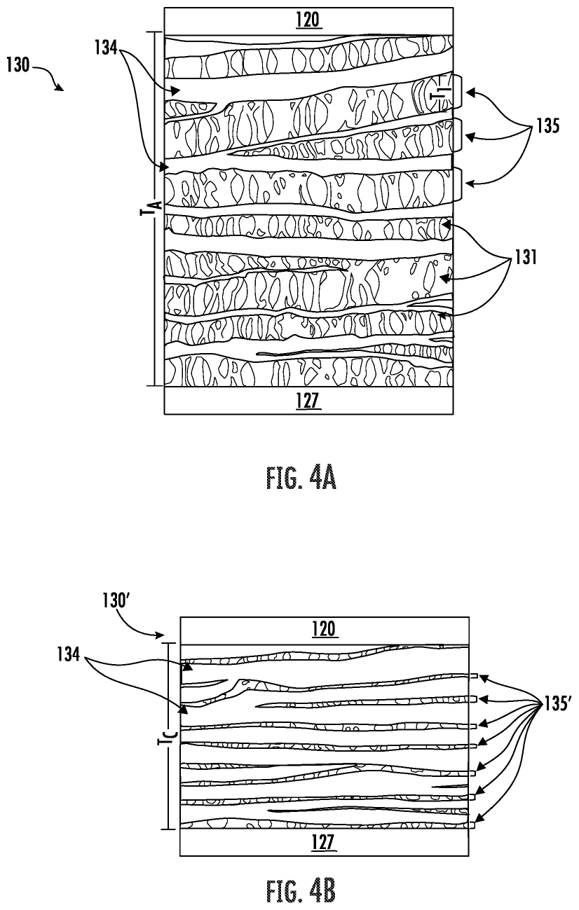

With reference to FIGS. 4A-B, the sealant 130 comprises multiple layers of sealant channels 135, each comprising discontinuous voids 131. Each sealant channel 135 may be bound by sealant channel walls 134. In this regard each sealant channel 135 may define a first thickness T₁.

The discontinuous voids 131 may extend between the sealant channel walls 134 in each of the sealant channels 135. In this regard, the discontinuous voids 131 do not extend through a total thickness T_{A} of the sealant 130. In some embodiments, the discontinuous voids 131 may not present in an array or alignment but may be randomly distributed throughout each of the sealant channels 135. In other embodiments, the discontinuous voids 131 may be disposed in an array or alignment.

The voids referenced herein may comprise any gaseous material entrapped within the sealant 130. In an embodiment, the voids comprise nano- and/or micro-scale air pockets. In an embodiment, the voids may present as bubbles within the sealant. In other embodiments, the voids may present as channels, matrixes, networks, or pores disposed within each of the sealant channels 135 of the sealant 130. In an embodiment, the voids and the sealant channels are not visible with the naked eye.

In an embodiment, the voids are formed by encapsulating particles within a melted polymer material (i.e., polyethylene), extruding the material (i.e., blown or cast film extrusion), and then stretching the film material in the machine direction or biaxially to create the voids. The particles physically separate from the polymer to create the voided structure. Any particles or additives known in the art may be used herein to create the voided polymer. The separation of the particles may create layers within the sealant comprising discontinuous voids.

In another embodiment, the voids may be formed through cavitation. To explain, cavitation may occur in semi-crystalline polymers (e.g., polyethylene) when the polymer is subjected to uniaxial stretching above the polymers glass transition temperature. At the temperature cavities or voids form inside the polymer. The size of the cavities change as the polymer is stretched the polymer is subject to local strain, thereby creating larger, and random sized and positioned cavities within the body of the polymer. In this regard, voids formed through cavitation may be amorphous.

Not wanting to be bound by theory, it is believed that the force exerted on the polymer, either through extrusion or stretching which creates and expands the voids within the polymer creating the voided polymer, as used herein.

When the sealant 130 is subjected to heat and/or pressure the discontinuous voids 131, and therefore, the sealant channels 135 collapse, thereby decreasing the thickness of and increasing the density of the sealant 130. However, the channel walls 134 may maintain thickness, and/or continuity upon exposure to heat and/or pressure.

FIG. 4A illustrates the sealant 130 at application of the sealant 130 to the outer layer 120. In some embodiments, the sealant 130 may comprise multiple layers of sealant channels 135 where each layer provides cumulative barrier properties, due to the channel walls 134 being continuous or near continuous within the sealant 130. In some embodiments, the voids 131 may be discontinuous throughout the sealant 130 (e.g., due to the channel walls 134), thereby providing barrier properties to the inner body ply. The discontinuous voids 131 may provide both oxygen and moisture barriers, as oxygen and moisture are unable to penetrate through the discontinuous voids 131 due to the continuity of the channel walls 134.

The collapse of the voids causes the sealant 130′ to densify, while maintaining the barrier properties from the discontinuous voids 131. Further, the decrease in the thickness of the sealant 130′ may reduce the thickness of the seams, prevent or reduces bubbles and/or creases at the ends of the tubular container, specifically at connection points (e.g., a rim) for closures, endcaps and/or membranes, thereby providing a stronger, more sustainable hermetic seal for the container and improving overall barrier properties of the container as a whole.

To explain further, the sealant 130 may define a total thickness T_{A} with each sealant channel 135 defining define a first thickness T₁ at application. In some embodiments, each channel layer 135 may define a similar first thickness T₁, while in other embodiments the first thickness T₁ of each channel layer 135 may vary. Upon exposure to heat and/or pressure, the discontinuous voids 131 of each channel layer 135 may collapse such that the channel walls 134 are adjacent one another, as illustrated in FIG. 4B. In some embodiments, the discontinuous voids 131 may collapse 100% as illustrated in FIG. 4B, at least 98%, or at least 95%.

The channel layers 135 comprise polymer material, as the discontinuous voids are bound by the polymer material. Thus, when the discontinuous voids 131 collapse upon exposure to heat and/or pressure the channel layer 135′ may exhibit a second thickness which is formed from the polymer material. In some embodiments, the second thickness may be at least a 5% reduction from the first thickness T₁, at least a 10% reduction in thickness from the first thickness T1, at least 15% reduction in thickness from the first thickness T₁, or even about a 20% reduction in thickness from the first thickness T1. In this regard, the sealant 130′ may define a collapsed thickness T_{C} which is about 5%, about 10%, about 15%, or even about 20% less than the total thickness T_{A} of the initial sealant 130.

In some embodiments, the sealant 130, before and after collapse of the voids, may provide barrier properties to the container. In an example embodiment the voided polymer sealant may provide a moisture barrier, measured at 26.7° C., and 80% relative humidity of between 0.1-0.4 g/100 in²/day, between 0.15-0.35 g/100 in²/day, or even between 0.2-0.3 g/100 in²/day In some embodiments, the sealant may provide a moisture barrier of less than 0.4 g/100 in²/day, less than 0.35 g/100 in²/day, less than 0.3 g/100 in²/day or even less than 0.25 g/100 in²/day. In some embodiments, the sealant layer may provide barrier properties, which are equivalent to a traditional barrier layer.

The voided polymer sealant may also provide an oxygen barrier, before and after collapse of the voids. For example, the oxygen barrier, measured at 23° C., 0% relative humidity, and in 100% oxygen, may be less than 30 cc/100 in²/day, less than 20 cc/100 in²/day, or less than 14 cc/100 in²/day. In some embodiments, the oxygen barrier may be between 5-20 cc/100 in²/day, between 7-15, or even between 10-15 cc/100 in²/day, which is equivalent to a traditional barrier layer.

Surprisingly, when applied at the same thickness (e.g., T_{A}) the weight of the traditional barrier layer may be greater than the weight of the voided polymer sealant. The difference in the weight is accounted for by the voids of the polymer sealant. Thus, the sealant layer 130 may be more lightweight than other barrier layers. For example, when the thickness of the traditional barrier layer and the voided polymer sealant layer is 15.5 microns, the weight of the traditional barrier layer may be 15.5 gsm, while the voided polymer sealant may be 13.8 gsm. Thus, in comparison to the traditional barrier layer, less of the voided polymer sealant is needed to produce the same barrier properties.

Therefore, the sealant 130 is able to provide a comparable barrier layer to a traditional barrier layer while using less product and provide varying thicknesses of the sealant 130 throughout the container. In this regard, the voids within the sealant layer 130 may be collapsed in certain positions, and not in others.

In some embodiments, the sealant 130 is extruded onto the outer layer 120. In other embodiments, the sealant 130 may be adhered to the outer layer 120. To create the collapsed portion (e.g., 130′) within the seam, during formation, the inner body ply 110 (e.g., the sealant 130 and the outer layer 120) is wound to form the container, and the seam may be exposed to heat and/or pressure to secure the inner body ply. The sealant 130′ within the seam may collapse, while the sealant 130 not within the seam may not collapse. Thus, the reduction in thickness at the seam due to the collapsed sealant 130′ may reduce any air gap formed due to the thickness differences between the seam and the inner body ply, thereby improving the hermicity of the container. To explain, although there are multiple body ply layers 110 the collapsed sealant 130′ provides a reduction in thickness at the seam as compared to the sealant 130 not along the seam.

Returning to FIGS. 3A-E, the sealant 130 is applied to the outer layer material 120 such that the sealant channels (e.g., 235 FIG. 4A) are parallel to the outer layer material 120. With reference to FIG. 20, after application of the sealant 130, the second edge 113 of the inner body ply 110 may be folded such that the outer layer material 120 is disposed within the interior of a fold 117. The fold 117 is formed by folding a peripheral distance 113a of the second edge 113 of the inner body ply 110 such that the first surface 110a of the peripheral distance 113a of the second edge 113 is disposed within the interior of the fold 117. The exterior of the fold 117 may comprise the second surface 110b of the inner body ply 110, which is the sealant layer 130.

In some embodiments, an adhesive 119 may be positioned on the first surface 110a of the inner body ply 110 in the interior of the fold 117. The adhesive 119 may secure the fold 117 prior to winding.

In some embodiments, the fold 117 may define a first fold thickness T_{F1} upon formation. The first fold thickness T_{F1} includes two layers of the sealant 130, two layers of the outer layer 120, and in some embodiments the fold adhesive 119.

After folding the inner body ply 110, the inner body ply 110 may be wrapped around in a helical fashion with the sealant 130 positioned on the interior of the resulting tubular container.

As the inner body ply 110 is wrapped the first edge 111, is brought into contact with the fold 117 formed in the second edge 113, forming an overlap 116 therebetween. As would be readily understood by one of ordinary skill in the art, the inner body ply 110 could also be wrapped longitudinally to form a convolute container.

With reference to FIG. 3D, the overlap 116 is formed between the first edge 111′ of the ensuing portion of the inner body ply 110′, and the fold 117 formed in the second edge 113, such that the sealant 130 on the first edge 111′, and the sealant 130 of the second edge 113 are in face-to-face contact.

After winding, the inner body ply 110 may be exposed heat and/or pressure causing the voids within the sealant 130 to collapse. Thus, as discussed with reference to FIGS. 4A-B, when the voids and sealant channels within the sealant collapse, the channel walls remain continuous or near continuous within the sealant thereby providing barrier properties throughout the collapsed sealant.

In some embodiments, the entire inner body ply 110 may be exposed to heat and/or pressure, while in other embodiments only the body ply 110 within the overlap 116 may be exposed to heat and/or pressure. As illustrated in FIG. 2E, the heat and/or pressure applied to the overlap 116 forms a seam 115 between the sealant 130 of the second edge 113 of the fold 117 and the first edge 111′ of the ensuing portion of the body ply 110.

The heat and pressure cause the voids within the sealant 130 to collapse, yielding a second fold thickness T_{F2} across the fold 117, wherein the second fold thickness T_{F2} is less than the first fold thickness T_{F1}. In this regard, the reduction of thickness within the seam 115 reduces the likelihood that the contents of the container (e.g., chips) will pierce through the barrier layer(s) at the seam, as the seam 115 is not as thick as when the sealant 130 does not collapse, thereby providing consistent barrier properties throughout the container.

In some embodiments, upon heating, the sealant 130 may decrease in thickness by at least 5%, at least 7%, at least 10% or even, at least 20%. The decrease in thickness causes the density of the sealant 130 to increase. In some embodiments, the sealant 130 may have at least a 5% change in density between the applied sealant and the collapsed sealant. In some embodiments, the change in density may be at least 7%, and in some embodiments may even be greater than a 10% change in density.

In an example embodiment, the sealant 130 may be applied to the outer layer 120 at a first thickness of 11 microns. The sealant 130 may define a density of 0.88 g/cm³ at application. After exposure to heat and pressure the density may increase to 0.93 g/cm³. Thus, for an application of sealant of 11 microns, each layer of sealant may decrease to about 10.4 microns thick. In this regard, a greater initial thickness may yield a greater change in density of the sealant, as there may be a greater volume of voids which may collapse.

After winding the continuous tube formed may be cut into discrete lengths to form the container 200. The ends of the container 200 may be rolled to form a bead or flange. The container 200 may be filled with product and sealed on one or both ends with a membrane and optionally an end cap may be positioned over the end. It should be understood that the voided polymer sealant discussed herein could be used within any fold, seam, juncture or other portion of a package which requires or would benefit from a smaller size, increased density, or improved barrier properties.

What is claimed is:

1. A tubular container for products comprising:
an inner body ply wrapped into a tubular shape comprising an outer layer and a sealant layer in face-to-face contact with the outer layer, wherein the outer layer defines a first surface of the inner body ply and the sealant layer defines a second surface of the inner body ply,
wherein the inner body ply further comprises a first edge and a second edge, wherein the second edge is folded such that the second surface of the inner body ply adjacent the second edge contacts the second surface of the inner body ply adjacent the first edge to form an overlap, wherein the first surface is disposed within the interior of the fold,
wherein the inner body ply further defines a seam formed in at least a portion of the overlap,
and wherein the sealant layer is a voided polymer sealant; and
an outer body ply wrapped around the first surface of the inner body ply.

2. The tubular container of claim 1, wherein the voided polymer sealant is a light-weight voided polymer sealant.

3. The tubular container of claim 1, wherein the voided polymer sealant is polyethylene.

4. The tubular container of claim 1, further comprising an adhesive disposed on the first surface of the body ply within the interior of the fold.

5. The tubular container of claim 1, wherein the voided polymer sealant is polypropylene.

6. The tubular container of claim 1, wherein the voided polymer sealant is polyethylene terephthalate.

7. The tubular container of claim 1, wherein the outer layer comprises a composite material.

8. The tubular material of claim 1, wherein the outer layer comprises a fibrous paperboard.

9. The tubular container of claim 1, further comprising a label ply having an inner surface adhered in face-to-face contact with the outer body ply.

10. The tubular container of claim 1, wherein the outer body ply is adhesively attached to the first surface of the inner body ply.

11. The tubular container of claim 1, further comprising a liner adhesively attached second surface of the inner body ply.

12. A method of forming a tubular container for products, the method comprising:
supplying an outer layer defining a first outer layer surface and a second outer layer surface;
applying a sealant to at least a portion of the second outer layer surface, wherein the sealant and the outer layer form an inner body ply, wherein the outer layer defines a first surface of the inner body ply, and the sealant defines a second surface of the inner body ply, wherein the inner body ply further defines a first edge and a second edge opposite the first edge;
folding the second edge of the inner body ply such that the first surface is disposed within the interior of the fold;
winding the inner body ply to form a seam between the first surface of the first edge of the body ply and the first surface of the folded second edge of the body ply;
applying at least one of heat or pressure about the seam, wherein the sealant is a voided polymer sealant;
applying an adhesive to an inner surface of an outer body ply; and
winding the outer body ply about the inner body ply, such that an inner surface of the outer body ply is in face-to-face contact with the first surface of the inner body ply.

13. The method of claim 12, further comprising:
applying an adhesive to an inner surface of a label ply; and
winding the label ply about the outer body ply such that an outer surface of the outer body ply is in face-to-face contact with the inner surface of the label ply.

14. The method of claim 12, further comprising:
winding a liner such that the liner is adjacent the second surface of the inner body ply.

15. The method of claim 12, wherein the voided polymer sealant is one of polyethylene, polypropylene, or polyethylene terephthalate.

16. The method of claim 12, wherein the voided polymer sealant reduces in thickness by at least 10% when exposed to one of heat or pressure.

17. The method of claim 12, wherein the voided polymer sealant increases in density by at least 5% when exposed to at least one of heat or pressure.

18. The method of claim 12, wherein the voided polymer sealant is flood coated onto the second surface of the second outer layer surface.

19. A tubular container for products comprising:
a spirally-wound inner body ply layer in strip form defining an inner layer of a substantially cylindrical tubular container;
a spirally-wound outer body ply layer in strip form defining an outer layer of the substantially cylindrical tubular container, wherein the outer body ply layer is wrapped around the outer surface of the inner body ply layer, wherein the tubular container comprises a first end and a second end opposite the first end,
the inner body ply comprising a first edge and a second edge, wherein the first edge and the second edge extend longitudinally in strip form, wherein the first edge and the second edge overlap, thereby defining a seam between the first edge of the inner body ply and the second edge of the inner body ply,
wherein the inner body ply layer defines a first surface and a second surface, the first surface comprising an outer layer in face-to-face contact with the outer body ply layer, and the second surface comprising a sealant layer, wherein the sealant layer is in face-to-face contact with the outer layer,
wherein the sealant layer is a voided polymer sealant.

20. The tubular container of claim 19, further comprising:
a spirally-wound liner in strip form defining an inner layer of the substantially cylindrical tubular container, wherein the liner is in face-to-face contact with the sealant layer.
